(19) United States
(12) Patent Application Publication
(10) Pub. No.: US 2005/0218785 A1
(43) Pub. Date: Oct. 6, 2005

(54) Electron emission display

(76) Inventors: Jae-Hoon Lee, Suwon (KR); Hyeong-Rae Seon, Busan (KR)

Correspondence Address: Robert E. Bushnell, Suite 300, 1522 K Street, N.W., Washington, DC, 20005, US

(21) Appl. No.: 11/085,260

(22) Filed: Mar. 22, 2005

(30) Foreign Application Priority Data
Mar. 30, 2004 (KR) 2004-21861

(51) Int. Cl. H01J 1/62

(52) U.S. Cl. 313/495

(57) ABSTRACT

An electron emission display comprises: a first plate and a second plate disposed in opposition to each other; a first electrode and a second electrode formed on the first plate and insulated from each other; an electron emission region connected to the first electrode or the second electrode for emitting electrons; a third electrode formed with at least one opening through which the electrons emitted from the electron emission region pass; a spacer supporting the first plate and the second plate so that they are spaced apart from each other; a metal coating layer formed on at least one region of the third electrode facing the spacer; a fourth electrode formed on the second plate; and a fluorescent layer connected to the fourth electrode. With this configuration, abnormal light-emission due to the spacer is prevented.

### CLAIM OF PRIORITY

This application makes reference to, incorporates the same herein, and claims all benefits accruing under 35 U.S.C. § 119 from an application entitled ELECTRON EMISSION DISPLAY filed with the Korean Intellectual Property Office on 30 Mar. 2004, and there duly assigned Ser. No. 2004-21861.

### BACKGROUND OF THE INVENTION

1. Technical Field

The present invention relates to an electron emission display and, more particularly, to an electron emission display in which a metal coating layer is formed on at least one region of the grid electrode facing the spacer, thereby preventing abnormal light-emission from arising due to a spacer after an annealing process.

2. Related Art

Generally, an electron emission device is classified into a hot cathode type or a cold cathode type, wherein the hot cathode type and the cold cathode type employ a hot cathode and a cold cathode, respectively, as an electron emission source. A cold cathode type electron emission device comprises a structure such as a field emitter array (FEA), a surface conduction emitter (SCE), a metal insulating layer metal (MIM), a metal insulating layer semiconductor (MIS), and a ballistic electron surface emitting (BSE).

The foregoing electron emission devices are employed in order to provide an electron emission display, various backlights, and a lithography electron beam. Among these, the electron emission display comprises an electron emission region provided with an electron emission device to emit the electron, and an image-displaying region in which the emitted electron collides with a fluorescent material to emit light. Generally, the electron emission display comprises: a plurality of electron emission devices formed on a first plate; a driving electrode to control the electron emission of electron emission devices; a fluorescent layer formed on a second plate and colliding with the electron emitted from the first plate; and a focusing electrode to effectively accelerate the electron toward the fluorescent layer.

The conventional electron emission display comprises an anode plate and a cathode plate.

On the cathode plate, the following are sequentially formed: a cathode electrode having a stripe shape; an insulating layer formed on the cathode electrode; and a gate electrode formed on the insulating layer, and having a stripe shape situated transversely to the cathode electrode. The insulating layer on the cathode electrode is formed with a plurality of holes, and an electron emission region is formed on portions of the cathode electrode exposed through the holes and emits electrons. The gate electrode is formed with a plurality of openings corresponding to the holes of the insulating layer so that the electrons emitted from the electron emission region are emitted toward the anode electrode.

On the anode plate, an anode electrode having a stripe shape and a fluorescent layer applied to the anode electrode are sequentially formed. Instead of the stripe shape, the anode electrode may be formed integrally with the anode plate throughout an inner surface of the anode plate. With this configuration, the electrons are emitted from the electron emission region toward the anode electrode, and they collide with the fluorescent layer, thereby emitting light.

Additionally, a grid electrode is provided on the gate electrode to control the electrons emitted from the electron emission region and traveling between the gate electrode and the anode electrode. On the grid electrode, a spacer is provided to maintain a constant distance between the anode plate and the cathode plate. The spacer is likely to be charged up by the missing electrons emitted from the electron emission region.

In the conventional electric emission display with a grid electrode, an oxide film is likely to be created on the surface of the grid electrode while being annealed, particularly, on a surface of the grid electrode facing the spacer. Therefore, when voltage is applied to the conventional electric emission display and the electron emission region emits the electrons, the created oxide film may function as a resistance between the grid electrode and the spacer. Hence, the spacer charged with the missing electrons is not easily discharged through the grid electrode because of the oxide film, so that not only are the electrons traveling toward the anode electrode-deflected, but also abnormal light-emission arises in a region around the spacer.

### SUMMARY OF THE INVENTION

Accordingly, it is an aspect of the present invention to provide an electron emission display in which at least one region of a grid electrode facing a spacer is coated with a metal layer and then contacts the spacer, thereby preventing abnormal light-emission due to the spacer after an annealing process.

The foregoing and/or other aspects of the present invention are achieved by providing an electron emission display which comprises: a first plate and a second plate disposed in opposition to each other; a first electrode and a second electrode formed on the first plate and insulated from each other; an electron emission region connected to the first electrode or the second electrode and emitting electrons; a third electrode formed with at least one opening through which the electrons emitted from the electron emission region pass; a spacer supporting the first plate and the second plate and spaced apart from each other; a metal coating layer formed on at least one region of the third electrode facing the spacer; a fourth electrode formed on the second plate; and a fluorescent layer connected to the fourth electrode.

Various aspects or features of the invention include the following: the metal coating layer includes a metal or alloy having a conductivity of 3×10⁵ (Ω··cm)⁻¹ or more; the metal coating layer includes silver (Ag) or gold (Au); the third electrode is formed with the metal coating layer at the upper surface thereof or at the lower surface thereof; the electron emission display comprises an insulating layer interposed between the third electrode and the metal coating layer; the metal coating layer is deposited at a thickness of about 1,000 Å to 10,000 Å by a sputtering process; the electron emission display further comprises an optical interception film provided on an inner surface of the second plate; the electron emission display further comprises a metal reflecting film provided on an inner surface of the second plate; the electron emission region comprises a carbon nano-tube (CNT), graphite, diamond, diamond-like carbon (DLC) or a combination thereof: the electron emission region comprises a nano-tube, a nano-wire of silicon (Si), or silicon carbide (SiC); the third electrode comprises a metal mesh; and the third electrode includes stainless steel, Suss, Invar, or an Fe—Ni alloy.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic sectional view of an electron emission display according to an embodiment of the present invention;

FIG. 2 is an enlarged perspective view of a “B”-region in FIG. 1;

FIG. 3 is a plan view illustrating a spacer formed on a grid electrode of the electron emission display according to an embodiment of the present invention;

FIG. 4 is a sectional view taken along line A-A of FIG. 3 according to another embodiment of the present invention;

FIG. 5 is a sectional view taken along line A-A of FIG. 3 according to another embodiment of the present invention; and

FIG. 6 is a photograph showing no abnormal light-emission due to the spacer of the electron emission display according to an embodiment of the present invention.

FIG. 7 is a schematic sectional view of an electron emission display according to a comparative embodiment; and

FIG. 8 is a photograph showing abnormal light-emission due to a spacer in the electron emission display according to the comparative embodiment.

### DETAILED DESCRIPTION OF THE INVENTION

Hereinafter, preferable embodiments according to the present invention will be described in detail with reference to the accompanying drawings, wherein the preferred embodiments of the present invention are provided so as to be readily understood by those skilled in the art, and so that various modifications are apparent, the present invention not being limited to the embodiments disclosed herein.

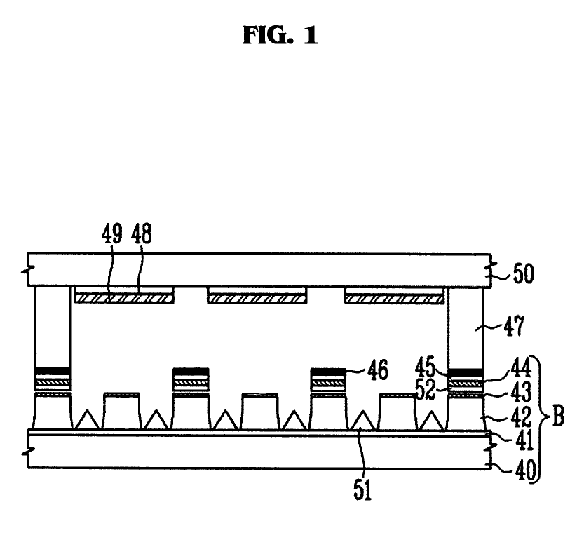

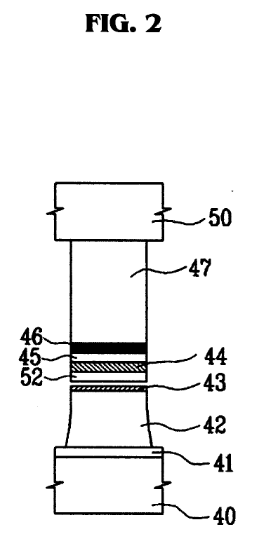

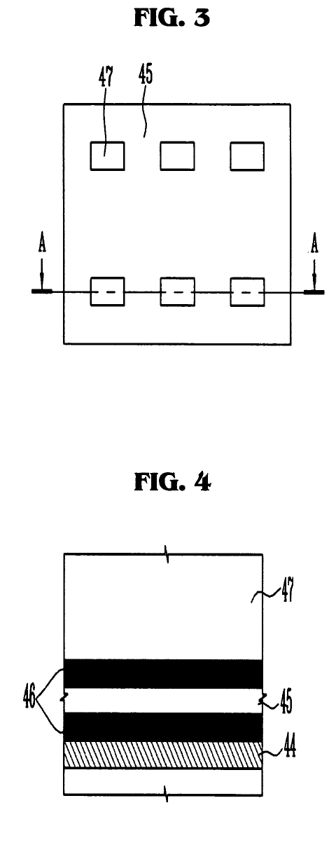

FIG. 1 is a schematic sectional view of an electron emission display according to an embodiment of the present invention; FIG. 2 is an enlarged perspective view of a “B”-region in FIG. 1; and FIG. 3 is a plan view illustrating a spacer formed on a grid electrode of the electron emission display according to an embodiment of the present invention.

Referring to FIGS. 1 and 2, an electron emission display according to the present invention comprises: a first plate 40 and a second plate 50 disposed in opposition to each other; a first electrode 41 and a second electrode 43 insulated from each other on the first plate 40; an electron emission region 51 connected to the first electrode 41 or the second electrode 43, and emitting electrons; a third electrode 45 formed with at least one opening through which the electrons emitted from the electron emission region 51 pass; a spacer 47 supporting the first plate 40 and the second plate 50 so that they are spaced apart from each other by a predetermined distance; a metal coating layer 46 formed on at least one region of the third electrode 45 facing the spacer 47; a fourth electrode 48 formed on the second plate 50; and a fluorescent layer 49 connected to the fourth electrode 48.

In more detail, in an electron emission display comprising a grid electrode according to an embodiment of the present invention, an anode plate 50 made of transparent glass and a cathode plate 40 are coupled, leaving a predetermined space therebetween in a vacuum. To maintain this space, the spacer 47 is provided on the grid electrode 45 between the anode plate 50 and the cathode plate 40. On an inner surface of the cathode plate 40, a cathode electrode 41 having a stripe shape, and an insulating layer 42, are formed. The insulating layer 42 is formed with a hole through which the electron emission region 51, as an electron emission source, is exposed. On the insulating layer 42, the gate electrode 43 is formed with an opening corresponding to the hole of the insulating layer 42, so that the electrons travel from the electron emission region 51 to an anode electrode 48 via the hole and the opening. Further, on an inner surface of the anode plate 50, the anode electrode 48 and the fluorescent layer 49, formed on a surface of the anode electrode 48 facing the cathode plate 40, are sequentially formed. The anode electrode 48 is formed in, for example, a stripe shape, but it may be entirely formed on the inner surface of the anode plate 50.

Furthermore, the grid electrode 45 is provided between the gate electrode 43 and the anode electrode 48, and it controls the electrons emitted from the electron emission region 51. A metal coating layer 46 is formed on at least one region of the grid electrode 45 facing the spacer 47 so as to prevent abnormal light-emission due to the spacer 47 after the grid electrode 45 is annealed.

It is preferable that a sputtering process be used to deposit the metal coating layer 46. However, the metal coating layer 46 may be deposited by several well-known processes, such as a chemical vapor deposition method or a plasma enhanced chemical vapor deposition method.

Preferably, the metal layer 46 has high oxidation resistance so as to prevent the surface of the grid electrode 45 from being oxidized, and has a high conductivity so as to discharge the unnecessarily charged spacer. As an example, conductivities according to various kinds of metals at a temperature of 295K are shown in the following <Table 1>. As shown in <Table 1>, metals having relatively good conductivity include Au, Cu, Ag, and Al. Preferably, the metal coating layer 46 includes a metal or an alloy having a conductivity of 3×10⁵ (ω··cm)⁻¹ or more.

TABLE 1

| | Conductivity | | Conductivity |
|---|---|---|---|
| Metal | [10⁵(Ω · cm)⁻¹] | Metal | [10⁵(Ω · cm)⁻¹] |
| Mg | 2.33 | Ni | 1.43 |
| Cr | 0.78 | Cu | 5.88 |
| Fe | 1.02 | Zn | 1.69 |
| Mo | 1.89 | Ag | 6.21 |
| Au | 4.55 | W | 1.89 |
| Al | 3.66 | Pt | 0.96 |

Furthermore, the metal coating layer 46 includes a single metal or an alloy having high oxidation resistance. Among Au, Cu, Ag and Al as metals having high conductivity, Ag and Au are excellent in terms of oxidation resistance. Hence, the metal coating layer 46 preferably includes Ag or Au, and more preferably Ag.

The coating layer preferably has a thickness of about 1,000 Å or more, but is not limited to that thickness. Preferably, the maximum allowable thickness of the coating layer is 10,000 Å. More preferably, the coating layer has a thickness of about 5,000 Å.

Preferably, the electron emission region 51 comprises a carbon nano-tube (CNT), graphite, diamond, diamond-like carbon (DLC) or a combination thereof, a nano-tube, or a nano-wire of silicon (Si) or silicon carbide (SiC).

An insulating layer 44 is additionally provided on a lower surface of the grid electrode 45 in order to apply a frit 52 to the insulating 44. The grid electrode 45 can be attached to an upper surface of the gate electrode 43 by the frit 52 applied to the insulating layer 44.

For example, the metal coating layer 46 is formed on the entire region of an upper surface of the grid electrode 45. Hence, the metal coating layer 46 prevents the grid electrode 45 from being oxidized, and thus the resistance between the grid electrode 45 and the spacer 47 is not increased. As a result, not only are the electrons traveling toward the anode electrode 48 prevented from being deflected due to the undischarged spacer 47, but also abnormal light-emission is prevented from arising in a region around the spacer 47.

Below, a method of fabricating the electron emission display according to an embodiment of the present invention will be described.

The grid electrode 45 has a predetermined shape. Therefore, to prevent the grid electrode 45 from being deformed, the grid electrode 45 is processed by a pre-treatment process, such as a pre-fire process.

The grid electrode 45 can include stainless steel, Suss, Invar, Fe—Ni alloy or the like, as well as a general conductive material. Meanwhile, the grid electrode 45 is formed with holes corresponding to the red, green and blue fluorescent layers forming one pixel. Thus, the electron beam (electrons) emitted from the electron emission region 51 passes through the hole.

At this point, the insulating layer 44 may be formed on the lower surface of the grid electrode 45 in order to prevent interference between grid electrode 45 and gate electrode 43. Further, the grid electrode 45 may have a groove or hole through which the spacer 47 may be inserted.

After the pre-fire process, the metal coating layer including Ag or the like is deposited on an upper surface of the grid electrode 45. After the deposition of the metal coating layer, an insulating material is applied to the lower side of the grid electrode 45 by a thick film method, such as a screen-printing method, and is then annealed so as to be crystallized, thereby forming the insulating layer 44. The grid electrode 45 formed with the insulating layer 44 is aligned with respect to the electron emission region 51 exposed through the gate holes of the cathode plate 40, and then firmly attached by the frit 52.

The spacer 47 is then formed on the grid electrode 45. Thereafter, the cathode plate 40 is coupled to the anode plate 50 comprising the anode electrode 48, and the fluorescent layer 49 formed on the anode electrode 48, thereby completing the fabrication of the electron emission display. In the latter regard, the anode electrode 48 and the fluorescent layer 49 are formed on the anode plate 50 by a well-known method. Furthermore, an optical interception layer (not shown) is additionally provided between the respective fluorescent layers 49. In addition, after the anode plate 50 and the cathode plate 40 are fabricated, the anode plate 50 is aligned with the cathode plate 40 by a well-known method and then annealed, thereby being assembled into the electron emission display. Additionally, to enhance electron focusing efficiency and electron reflection efficiency, a metal reflecting film (not shown) can be formed on an inner surface of the anode plate 50 facing the cathode plate 40.

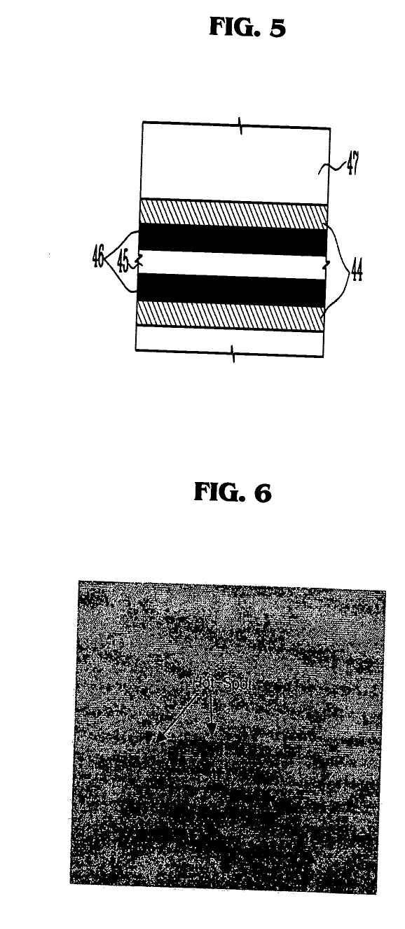

FIG. 3 is a plan view illustrating a spacer formed on a grid electrode of the electron emission display according to an embodiment of the present invention; FIG. 4 is a sectional view taken along line A-A of FIG. 3 according to another embodiment of the present invention; and FIG. 5 is a sectional view taken along line A-A of FIG. 3 according to another embodiment of the present invention.

As shown in FIGS. 3 through 5, the metal coating layers 46 are deposited on the upper and lower surfaces of the grid electrode 45. Referring to FIG. 4, the lower side metal coating layer 46 is in contact with the insulating layer 44. Referring to FIG. 5, both metal coating layers 46 are in contact with the insulating layers 44. As shown in FIG. 5, the insulating layer 44 interposed between the metal coating layer 46 and the spacer 47 prevents an arc from being generated when high voltage is applied to the grid electrode 45. Here, the metal coating layer 46 may be formed on only an upper surface of the grid electrode 45 as described above.

FIG. 6 is a photograph showing that there is no abnormal light-emission due to the spacer of the electron emission display according to a comparative embodiment of the present invention.

An electron emission display according to a comparative embodiment will be described below.

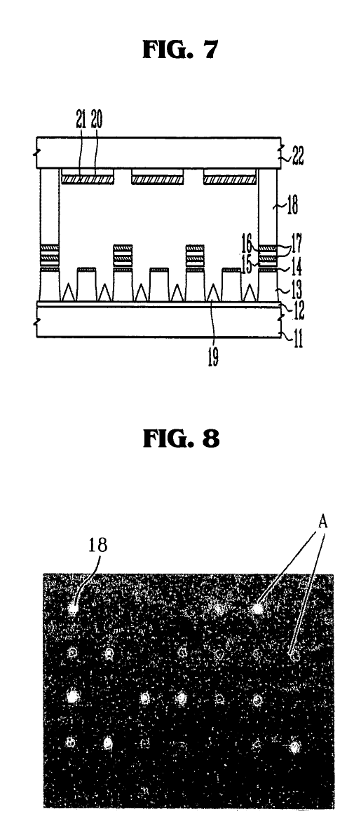

FIG. 7 is a schematic sectional view of an electron emission display according to the comparative embodiment, and FIG. 8 is a photograph showing abnormal light-emission due to a spacer in the electron emission display according to the comparative embodiment.

Referring to FIG. 7, the electron emission display comprises a transparent anode plate 22 and a cathode plate 11. On the cathode plate 11, the following are sequentially formed: a cathode electrode 12 having a stripe shape; an insulating layer 13 formed on the cathode electrode 12; and a gate electrode 14 formed on the insulating layer 13, and having a stripe shape situated transversely to the cathode electrode 12. The insulating layer 13 on the cathode electrode 12 is formed with a hole, and an electron emission region 19 is formed on a portion of the cathode electrode 12 exposed through the hole. Furthermore, the gate electrode 14 is formed with an opening corresponding to the hole, so that electrons emitted from the electron emission region 19 can travel toward an anode electrode 20.

On the anode plate 22, the anode electrode 20 having a stripe shape, and a fluorescent layer 21 applied onto the anode electrode 20, are formed in sequence. Instead of the stripe shape, the anode electrode 20 may be formed integrally with an inner surface of the anode plate 22. With this configuration, the electrons are emitted from the electron emission region 19 toward the anode electrode 20, and collide with the fluorescent layer 21, thereby emitting light.

Furthermore, a grid electrode 16, coated at an upper and lower side thereof with insulating layers 17 to prevent an arc, is attached to the gate electrode 14 by a fixing means, such as a frit 15, thereby controlling the electrons emitted from the electron emission region 19 and traveling between the gate electrode 14 and the anode electrode 20. Also, a spacer 18 is coupled to the grid electrode 16, thereby maintaining a constant distance between the anode plate 22 and the cathode plate 11.

However, in the electron emission display comprising the grid electrode 16 according to the comparative embodiment, the grid electrode 16 is formed of a metallic material so that the grid electrode 16 is likely to be oxidized while being annealed, resulting in abnormal light-emission.

FIG. 8 is a photograph showing abnormal light-emission due to a spacer in the electron emission display according to the comparative embodiment.

According to the inventors' research, an oxide film is likely to be created on the surface of the grid electrode 16 facing the spacer 18 while being annealed (for example). Therefore, when voltage is applied to the electric emission display and the electron emission region 19 emits electrons, the created oxide film increases the resistance between the grid electrode 16 and the spacer 18. Hence, the spacer 18 charged with the missing electrons is not easily discharged through the grid electrode 16 because of the oxide film. As a result, not only are the electrons traveling toward the anode electrode 20 deflected, but also abnormal light-emission arises in a region “A” around the spacer 18.

In comparison with the comparative embodiment, the electron emission display according to the embodiment of the invention as shown in FIGS. 1 and 2 comprises a metal coating layer 46 formed on at least one region of the grid electrode 45. Hence, the metal coating layer 46 prevents the grid electrode 45 from being oxidized, and thus the resistance between the grid electrode 45 and the spacer 47 is not increased. As a result, not only are the electrons traveling toward the anode electrode 48 prevented from being deflected due to the undischarged spacer 47, but also abnormal light-emission is prevented from arising in a region around the spacer 47.

In the foregoing embodiment, the structure of the anode electrode 48 formed with the fluorescent layer 49 and the cathode electrode 43 is described by way of example, but the invention is not limited thereto and may vary. For example, a fluorescent layer and a metal thin film may be sequentially formed on an anode plate.

Further, a metal back or the like may be additionally provided not only to reflect the light emitted from the fluorescent layer toward a cathode plate, but also to prevent damage due to secondary electrons. Additionally, in the foregoing embodiment, the insulating layer is formed on the cathode electrode and the gate electrode is formed on a portion of the insulating layer. However, the arrangement of the cathode electrode and the gate electrode is not limited and may vary as long as the cathode electrode and the gate electrode are insulated from each other.

That is, in the electron emission display according to an embodiment of the present invention, the cathode plate comprises the cathode electrode and the gate electrode, which are formed on the plate, and the anode plate comprises the anode electrode and the fluorescent layer, which are formed on the plate. However, the electron emission display according to an embodiment of the present invention may have various structures as long as the cathode plate emits the electrons through the electron emission region, and the anode plate emits light through the fluorescent layer, with which the emitted electrons collide.

As described above, the present invention provides an electron emission display comprising a metal coating layer formed on at least one region of the third electrode facing the spacer. Hence, the metal coating layer prevents the grid electrode from being oxidized and thus resistance between the grid electrode and a spacer is not increased. As a result, not only are the electrons traveling toward the anode electrode prevented from being deflected due to the undischarged spacer, but also abnormal light-emission is prevented from arising in a region around the spacer.

Although a few embodiments of the present invention have been shown and described, it should be appreciated by those skilled in the art that changes may be made in the disclosed embodiments without departing from the principles and spirit of the invention, the scope of which is defined by the appended claims and their equivalents.

1. An electron emission display, comprising:
a first plate and a second plate disposed in opposition to each other;
a first electrode and a second electrode formed on the first plate and insulated from each other;
an electron emission region connected to one of the first electrode and the second electrode for emitting electrons;
a third electrode formed with at least one opening through which the electrons emitted from the electron emission region pass;
a spacer supporting the first plate and the second plate so that the first plate and the second plate are spaced apart from each other;
a metal coating layer formed on at least one region of the third electrode facing the spacer;
a fourth electrode formed on the second plate; and
a fluorescent layer connected to the fourth electrode.

2. The electron emission display according to claim 1, wherein the metal coating layer comprises one of a metal and an alloy having a conductivity of at least 3×10⁵ (Ω··cm)⁻¹.

3. The electron emission display according to claim 1, wherein the metal coating layer comprises one of silver (Ag) and gold (Au).

4. The electron emission display according to claim 1, wherein the third electrode is formed with the metal coating layer on at least one of an upper surface thereof and a lower surface thereof.

5. The electron emission display according to claim 1, wherein the third electrode comprises a grid electrode having metal coating layers formed on upper and lower surfaces thereof.

6. The electron emission display according to claim 5, further comprising an insulating layer disposed on one of the metal coating layers.

7. The electron emission display according to claim 6, wherein the spacer is disposed on another of the metal coating layers.

8. The electron emission display according to claim 6, further comprising an insulating layer disposed on another of the metal coating layers.

9. The electron emission display according to claim 8, wherein the spacer is disposed on said another of the metal coating layers.

10. The electron emission display according to claim 1, further comprising an insulating layer interposed between the third electrode and the metal coating layer.

11. The electron emission display according to claim 1, wherein the metal coating layer is deposited with a thickness in a range of 1,000 Å to 10,000 Å by a sputtering process.

12. The electron emission display according to claim 1, further comprising an optical interception film provided on an inner surface of the second plate.

13. The electron emission display according to claim 1, further comprising a metal reflecting film provided on an inner surface of the second plate.

14. The electron emission display according to claim 1, wherein the electron emission region comprises one of a carbon nano-tube (CNT), graphite, diamond, diamond-like carbon (DLC), and a combination thereof.

15. The electron emission display according to claim 1, wherein the electron-emission region comprises one of a nano-tube, a nano-wire of silicon (Si), and silicon carbide (SiC).

16. The electron emission display according to claim 1, wherein the third electrode comprises a metal mesh.

17. The electron emission display according to claim 1, wherein the third electrode comprises one of stainless steel, Suss, Invar, and an Fe—Ni alloy

18. The electron emission display according to claim 1, wherein the fluorescent layer is disposed on a surface of the fourth electrode facing the electron emission region.

19. The electron emission display according to claim 1, further comprising an insulating layer disposed between the second electrode and the third electrode, and a frit disposed between the second electrode and the insulating layer.
